(19) United States
(12) Patent Application Publication
(10) Pub. No.: US 2019/0080115 A1
(43) Pub. Date: Mar. 14, 2019

(54) MAIL CONTENT ANONYMIZATION

(71) Applicant: CA, Inc., New York, NY (US)

(72) Inventors: M. Keerthidhara DONGRE, Bengalura (IN); Sharath KUMAR, Bangalore (IN)

(73) Assignee: CA, Inc.

(21) Appl. No.: 15/702,823

(22) Filed: Sep. 13, 2017

(51) Int. Cl. G06F 21/62; H04L 29/06

(52) U.S. Cl. CPC G06F 21/6254; G06F 21/6227; H04L 63/08; H04L 63/108; G06F 21/6245

(57) ABSTRACT

A method includes receiving content anonymization metadata from an anonymization server, and in response to receiving the content anonymization metadata, determining a plurality of messages related to identified sensitive content based on attributes of the content anonymization metadata. In addition, the method includes determining whether a message of the plurality of related messages includes the sensitive content, and in response to determining that a message includes the sensitive content, automatically anonymizing the sensitive content according to the content anonymization metadata.

### BACKGROUND

The present disclosure relates generally to data security and anonymization, and more specifically, to mail content anonymization.

### BRIEF SUMMARY

According to an aspect of the present disclosure, a system, method, and computer readable medium are provided wherein a client component receives content anonymization metadata from an anonymization server, and in response to receiving content anonymization metadata the client component may determine a plurality of messages related to a target sensitive content based on message header field data associated with a sensitive content identifier. Once the plurality of related messages is identified, the client component may non-intrusively and automatically anonymize the sensitive content according to the content anonymization metadata.

Other features and advantages will be apparent to persons of ordinary skill in the art from the following detailed description and the accompanying drawings.

### BRIEF DESCRIPTION OF THE DRAWINGS

Aspects of the present disclosure are illustrated by way of example and are not limited by the accompanying figures with like references indicating like elements.

FIG. 1 depicts an email content anonymization server component and method performed thereby for preparing anonymization metadata.

FIG. 2 depicts an email content anonymization client component and method performed thereby for anonymizing sensitive content.

FIG. 3 depicts the method for searching for messages related to sensitive content in accordance with content anonymization metadata.

FIG. 4 illustrates a high-level flow diagram of the mail content anonymization method.

FIG. 5 illustrates content anonymization metadata and method of updating and broadcasting content anonymization metadata.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely in software (including firmware, resident software, micro-code, etc.) or in a combined software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would comprise the following: a portable computer diskette, a hard disk, a random access memory (“RAM”), a read-only memory (“ROM”), an erasable programmable read-only memory (“EPROM” or Flash memory), an appropriate optical fiber with a repeater, a portable compact disc read-only memory (“CD-ROM”), an optical storage device, a magnetic storage device, or any suitable combination of the foregoing. In the context of this document, a computer readable storage medium may be any tangible medium able to contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take a variety of forms comprising, but not limited to, electro-magnetic, optical, or a suitable combination thereof. A computer readable signal medium may be a computer readable medium that is not a computer readable storage medium and that is able to communicate, propagate, or transport a program for use by or in connection with an instruction execution system, apparatus, or device. Program code embodied on a computer readable signal medium may be transmitted using an appropriate medium, comprising but not limited to wireless, wireline, optical fiber cable, RF, etc., or any suitable combination of the foregoing.

Computer program code for carrying out operations for aspects of the present disclosure may be written in a combination of one or more programming languages, comprising an object oriented programming language such as JAVA®, SCALA®, SMALLTALK®, EIFFEL®, JADE®, EMERALD®, C++, C#, VB.NET, PYTHON® or the like, conventional procedural programming languages, such as the “C” programming language, VISUAL BASIC®, FORTRAN® 2003, Perl, COBOL 2002, PHP, ABAP®, dynamic programming languages such as PYTHON®, RUBY® and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider) or in a cloud computing environment or offered as a service such as a Software as a Service (“SaaS”).

Aspects of the present disclosure are described herein with reference to flowchart illustrations and/or block diagrams of methods, apparatuses (e.g., systems), and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that, when executed, may direct a computer, other programmable data processing apparatus, or other devices to function in a particular manner, such that the instructions, when stored in the computer readable medium, produce an article of manufacture comprising instructions which, when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses, or other devices to produce a computer implemented process, such that the instructions which execute on the computer or other programmable apparatus provide processes for implementing the functions/acts specified in the flowchart and/or block diagram block or blocks.

With billions of registered email accounts, email is an accepted and traditional communication medium across the Internet and other networks. Email communications permeate the business and personal spheres. The adoption of email as a network communication tool can be attributed in large part to standardization. A leading body of such standardization efforts is the Internet Engineering Task Force (IETF), which is a collaborative community with the goal of facilitating smooth operation and evolution of the Internet. One of the more prevalent and well known documents published by the IETF is Request for Comments (RFC) 5322 (obsoletes 2822) specifying the Internet Message Format (IMF). This RFC, for example, provides a syntax and framework for email messages. By adopting the syntax and framework described in RFC 5322, computers are able to share messages using a common form which each can interpret.

With more people communicating via email, there has never been a more potent need to protect email communications from malicious and unwanted intrusion. And there is a heightened and unsatisfied need for ubiquitous protection of sensitive content carried via email.

Emails are often not one-off communications, given the ease with which one can respond, forward, or otherwise share a communication with several others. This leads to a unique Internet-centric issue presented by email and other internet communications whereby communications are grouped and visible together, for example, such as a thread or email chain. There could be many users included in such a thread, each responding to messages from other members of the thread, and sending messages out to the entire thread, resulting in a universe of messages surrounding or stemming from a root message or topic of discussion. A concern unique to email or messaging threads is that the originator of the thread cannot always control the other participants from forwarding or including new participants, with whom the original sender never intended to share their message. Utilizing standard features of email communications, new participants can be included such that no other users on the thread can detect them, for example, by including the new participant through a “blind carbon copy,” using the “BCC:” field. The Internet and email have made it easier than ever for communications to reach unintended recipients. Particularly of concern, is the situation where the original sender's message or a message in reply or response thereto, included content that one would consider sensitive.

There are various techniques for protecting email content during composition of a message. For example, one can use techniques of anonymization, tokenization, or encryption to shield sensitive content from unwanted recipients. Each of these techniques may involve communications, exchanges, and handshakes between a client component and a server component, or a plurality of both.

For example, with the use of tokens or tokenization, a token server or token vault may be utilized. The token server may employ a lookup table or codebook to search for a particular token and identify one or more other pieces of data associated with that token in a database. In some embodiments, the token system may be administered by a token service provider running a tokenization server and a token vault. A general description of the tokenization process is as follows. A user requests a token from the tokenization server. The token service provider then generates a token and the token replaces the sensitive content in the message. A recipient of the message with the tokenized data then queries the tokenization server and if authorized, the token server will enable the tokens to be replaced with the sensitive content.

Embodiments of the present disclosure may leverage the standardization of Internet message formats to provide a widely applicable and non-intrusive mail content anonymization technique that can enable anonymization of sensitive content at a client component using metadata.

Some embodiments within the present disclosure are best understood by way of a communication between a client component and a server component. Within the scope of the present disclosure, there may be one or more client components and/or one or more server components. A client component may be, in certain embodiments an email client program as are well known, such as Microsoft Outlook, or in other embodiments may be a plugin in such email client. In other embodiments, for example in the content of webmail service providers, the client component may be a browser helper object or browser plugin. In other embodiments, the client component may be a standalone messaging application or other communications application used to send messages and other information, or may be a plugin or module therein.

Whether it is an email client, webmail client, or standalone messaging application, the client component may have access to a mailbox. The mailbox may include messages from other users and their respective client components and attachments thereto. Thus, in certain embodiments herein, the client component has the ability to parse data appearing in different folders and subfolders, or in other words is able to parse a directory structure associated with the client component and is not limited in access to any one particular folder or directory. In some embodiments, the client component may access the messages and attachments to messages across mailbox folders associated with the client component.

Another component of the systems described herein is the anonymization server component, such as those which are well known in the art. Within the scope of the present disclosure, the anonymization server may control access to the sensitive data by maintaining a vault as is well known, preparing content-key identifiers used to lookup the sensitive content, and the like. The anonymization server sends and receives messages from the client components. For example, a client component may send a message to the anonymization server requesting anonymization serves. In such embodiments, the message from the client component may identify data associated with sensitive content. The anonymization server may prepare, based on the message received from the client component, content anonymization metadata. In certain embodiments, the prepared content anonymization metadata may be broadcast from the anonymization server to one or more client components. In general, such a broadcast may activate the client component to anonymize sensitive content, as is described herein. After such an anonymization has occurred, client components may interact with the server component to exchange information related to the sensitive content regarding requests for key lookups and requests to de-anonymize the sensitive contents.

In general, content anonymization metadata may be, in certain embodiments, a data set that describes and provides information about other data. For example, content anonymization metadata may include identifiers of messages and sensitive content, message header field data regarding messages in a mailbox, and other data that describes or provides information about content anonymization. The content anonymization metadata may concern content anonymization in the context of a mailbox or email system, instant messaging system, or systems providing similar communication and messaging services and abilities. Content anonymization metadata may further include, in certain embodiments a level of authorization or anonymization, which itself can describe and provide information about a level of authorization for a particular client component. In the same or alternative embodiments, content anonymization metadata may include a date range, and such date range may describe the amount of time or end date content may be anonymized.

Sensitive content is content that is considered private for example, social security numbers, date of birth, credit card numbers and associated account information, or other content that has been indicated as being sensitive. There are many ways of identifying sensitive content without using the sensitive content itself, for example, by some abstraction or representation of the sensitive content. A sensitive content identifier, as such is utilized in certain embodiments described herein, may include a unique identifier such as that used in a lookup table in an anonymization or token server. A sensitive content identifier may also include, in particular embodiments, a content-key prepared by an anonymization or tokenization server. In general, the sensitive content identifier is information that identifies the sensitive content without revealing the content of the sensitive content. In some embodiments within the scope of the present disclosure, the sensitive content identifier may identify an attachment to a message containing sensitive content. Such identification could be by a filename or other identifier such as a document number or timestamp. In such embodiments, it will be appreciated by one of skill in the art that the sensitive content need not appear directly in the body of a message, but rather, in an attachment thereto. Sensitive data can be selected or detected in exemplary embodiments. For example, in some embodiments the sensitive data is selected by a user on a mail client. In the same or other embodiments, the client may automatically identify and detect sensitive content using rules and policies set by a user or organization.

Some embodiments within the scope of the present disclosure leverage email structures to accomplish non-intrusive content anonymization. While the underlying structure of email communications, such as that described in RFC 5322, may be unknown to many if not most users of email, it is vital to internet mail communications because there are many different options and email providers available. By adopting such a standard and implementing its core features, email systems from different providers may communicate seamlessly.

Emails can be viewed as an envelope and contents, such as a letter. As RFC 5322 describes, “[t]he envelope contains whatever information is needed to accomplish transmission and delivery.” The envelope itself is further standardized, as discussed in RFC 5321, for example. The content of the envelope, such as the letter with the actual message to be delivered, has its own standardized form and syntax to enable different email providers to interface with one another.

Some of the standardized message fields are known as message header fields, or the header section of a message. The header section is optionally followed by the body of the message. Message header fields often correspond to the form entry fields one sees at the top of the message composition window when drafting an email, as well as many others. The message header fields are comprised of a field name, such as “to,” followed by a colon, followed by a field body, such “recipient@email.com,” the recipient's email address. Other message header fields may include, but are not limited to “from,” “sender,” “reply-to,” “cc,” “bcc,” “message-id,” “in-reply-to,” “references,” “subject,” “comments,” and “keywords.” Message header fields are also categorized in several ways. For example, originator fields (e.g., from, sender, reply-to), destination address fields (e.g., to, cc, bcc), identification fields (e.g., message-id, in-reply-to, references), and informational fields (e.g., subject, comments, keywords).

While not directly revealed to the email user in traditional email systems, many of the message header fields are automatically populated when composing emails. First, a “message-id” field should accompany every message and should comprise a unique identifier for that message, and particularly, that version of that message. If a revision is made to that message, it will be assigned a new “message-id.” Because the “message-id” is not of importance to humans, it is often only machine readable and used only by the back-end of the email communication platform. Fields like “in-reply-to” and “references” for example are used when replying to a message, and may identify the original or root message to which a reply or reference is being made in the field body. These fields may hold the message identifier of the original or root message as well as other messages, for example, in the case of a reference to a reply to the original root message. In addition, the “in-reply-to” field may contain not only the message identifier of the message to which it directly replies, but also the message identifier of messages to which the directly replied to message was in reply to. Thus, the field body of the message fields may be used to trace an email conversation back to a root message. Along those lines, the “references” field may be used to identify a message “thread,” or a conversation. Additional details of the various message header fields and their operation and specification can be found in RFC 5322 and other IETF documentation.

There may be many ways to associate message header field data with the sensitive content and/or the sensitive content identifier within the scope of the present disclosure. In general, the message header field data that is associated with the sensitive content identifier, in some embodiments described herein, is utilized by other aspects of the present disclosure to identify other messages or instances of the sensitive content in a user's mailbox. The header field data may be associated with the sensitive content identifier by, for example, including the message identifier of a message that contained the sensitive content. In some embodiments, the message identifier may be a message identifier of a root message containing the sensitive content. Therefore, in certain embodiments, the content anonymization metadata may comprise a content-key pair identifying the sensitive content and an identifier of the message in which the sensitive content is included. An identifier of a root message refers to, in some embodiments, an identifier of the message that is the original instantiation of the sensitive content in a conversation, thread, or other chain of messages. In other embodiments, the message header field data associated with the sensitive content may be an identifier of a message which is not the root message or original instantiation of the sensitive content, but rather, some other message in the chain or a message forwarded, replied, or otherwise referencing a message that includes the sensitive content. For example, rather than the message header field data directly including an identifier of the root message containing the sensitive content, the message header field data may include an identifier of the recipient's reply to the root message, or some further message in the thread, wherein the sensitive content is included in the message chain forming part of the message.

In certain embodiments, there may be several ways in which the content anonymization metadata comprises message header field data associated with the sensitive content identifier, including but not limited to including an identifier of a message that is related to the sensitive content and can be used to identify a plurality of messages related to the sensitive content, in the message identifier, in-reply-to, or references standard message header fields as described above.

In other embodiments, the message header field data may include a level of authorization. In such embodiments, the level of authorization may be a level of anonymization that is associated with a particular client component or user client component. The level of authorization or anonymization provides the ability to selectively control access to the sensitive content such that some client components who receive the sensitive content may be able to identify it using the content anonymization metadata and the message header field data therein, and anonymize it according to the metadata, but may not be authorized to de-anonymize the content thereby leaving it protected in all instantiations in the mailbox associated with the client component. For example, a level of authorization may be set based on work groups or departments within an organization, such as the engineering department, sales and marketing, information technology, support services, and many others. There may be a default level of authorization associated with each department or workgroup, or in other embodiments the level of authorization may be custom to the situation or otherwise modifiable to depart from the default. In other embodiments, a level of authorization may be specified based upon rank, job title, or role. In such embodiments, the content anonymization metadata could specify that only senior project managers are able to de-anonymize the sensitive content from the server component. The level of authorization could identify a particular client component, for example, by a username or employee identifier.

In certain embodiments, the level of authorization may specify a percentage of sensitive content to be replaced. In such embodiments, for example, a first level of authority may be given access to one hundred percent of the sensitive data. A second level of authority may be given access to seventy five percent of the sensitive data, and a third level of authorization may be given access to fifty percent of the sensitive data. Other levels of authorization are contemplated, and the three percentage levels described above are exemplary. In such an embodiment for example, a fourth level of authorization may correspond to no access to the sensitive data, i.e., zero percent.

In embodiments wherein a level of anonymization is included with the content anonymization metadata, the sensitive content is protected in that some client component instantiations of the sensitive content will be able to de-anonymize and display the true sensitive content while other client components will not. For example, upon receiving content anonymization metadata including a sensitive content identifier and associated message header field data, the client component may search using the techniques described herein across a mailbox comprising a plurality of folders for messages containing the sensitive content by using the sensitive content identifier and the message header field data. Upon identifying one or more instantiations of the sensitive content, the sensitive content may be anonymized by the client component according to the level of anonymization or the class of anonymization applying to that particular client component. If the client component is one for which access to the true sensitive data is not desired, the client component will anonymize the sensitive content but will not be able to retrieve the sensitive content from the server component to de-anonymize it. Thus, the sensitive content is protected and accessible only to authorized client components or users.

Another customizable aspect of the anonymization which may be included in the content anonymization metadata is a date range associated with the anonymization. Upon receiving such metadata, any instantiations of the sensitive content may be anonymized for a specified time period. For example, suppose the sensitive content to be anonymized is a public release date for a secret product. After the release date occurs, or on the release date, that information may no longer be sensitive now that the actual release has occurred. In such an exemplary scenario, the client component may de-anonymize the sensitive content, for example, upon receiving a message from the server component regarding such expiration or in response to local detection or such expiration.

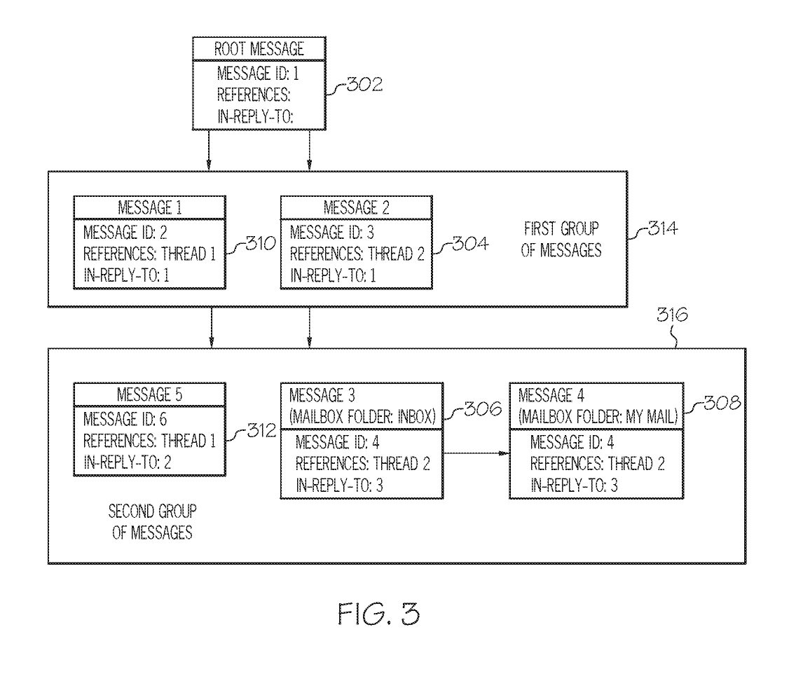

Upon receiving content anonymization metadata from an anonymization server, the client component may identify one or more messages related to the sensitive content utilizing the metadata to conduct an analysis and search of a mailbox. The search of the mailbox may constitute a search across all directories and subdirectories within the mailbox including attachments to messages in the mailbox. There may be, in certain embodiments, different levels of relativity to the sensitive content. Referring to FIG. 3, for example, there may be a first group of messages 314 with message header data directly referencing the message identifier of the root message 302 containing the sensitive content. That is, in certain embodiments a first group of messages may include messages that directly reference a message identifier of a message containing sensitive data in one or more message header data fields including but not limited to the references, in-reply-to fields, such as messages 304 and 310. By parsing the message header fields of messages within the mailbox, the client component 100 is able to identify a set or group of messages that are one-degree separated from a message that contains the sensitive data. At a second level, a second group of messages 316 may be comprised of messages that reference a message in the first group of messages, thereby comprising in this embodiment a group of messages that are twice removed from a message containing the sensitive content. In other words, the second group of messages may comprise messages that reference a message that references a message identifier associated with the sensitive content. In this way, as is explained in greater detail below, the client component is able in particular embodiments to identify a set of messages that are related to the sensitive content identifier including message chains and threads of messages, such as Thread 1 and Thread 2 depicted in FIG. 3.

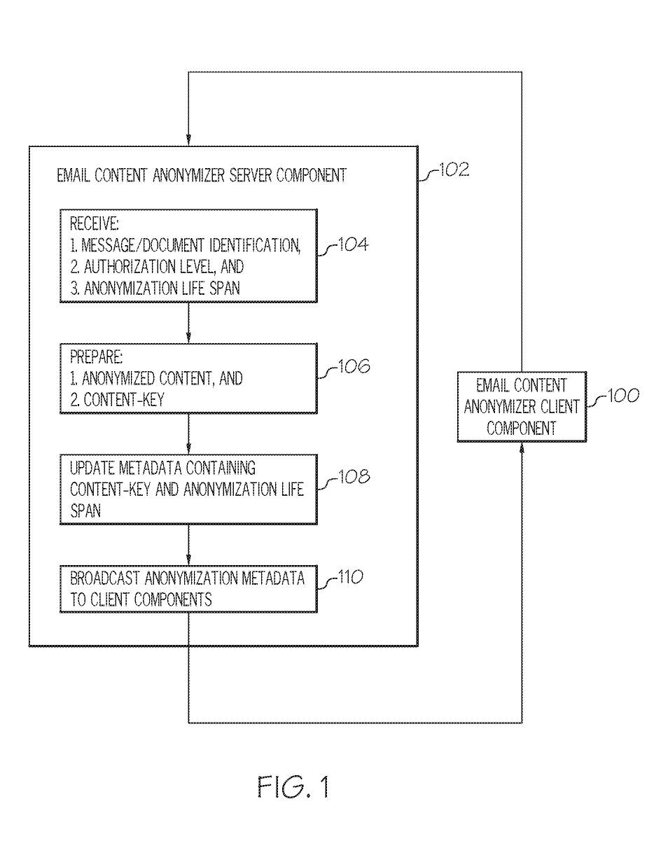

Referring now to FIG. 1 depicting a particular embodiment of the present disclosure, an email content anonymizer server component 102 receives from an email content anonymizer client component 100 data regarding message and/or document identification, an authorization level, and an anonymization life span or time period, as shown in 104. A client component 100 may send this information to the server component 102 through a request for anonymization and the message comprises one or more parameters of the anonymization, as described above. Upon receiving the anonymization message, the content anonymizer server component 102 prepares the anonymized content and a corresponding content-key pair, as shown in 106. A content-key may be a Globally Unique/Universally Unique ID (GUID/UUID), generated using standard techniques such as MD5 or SHA1, and the like. Examples of such content-keys are 123e4567-e89b-12d3-a456-426655440000 or 03474328572_44bc5511-5834-4407-9481-96e026036423. Standard key generation techniques are leveraged.

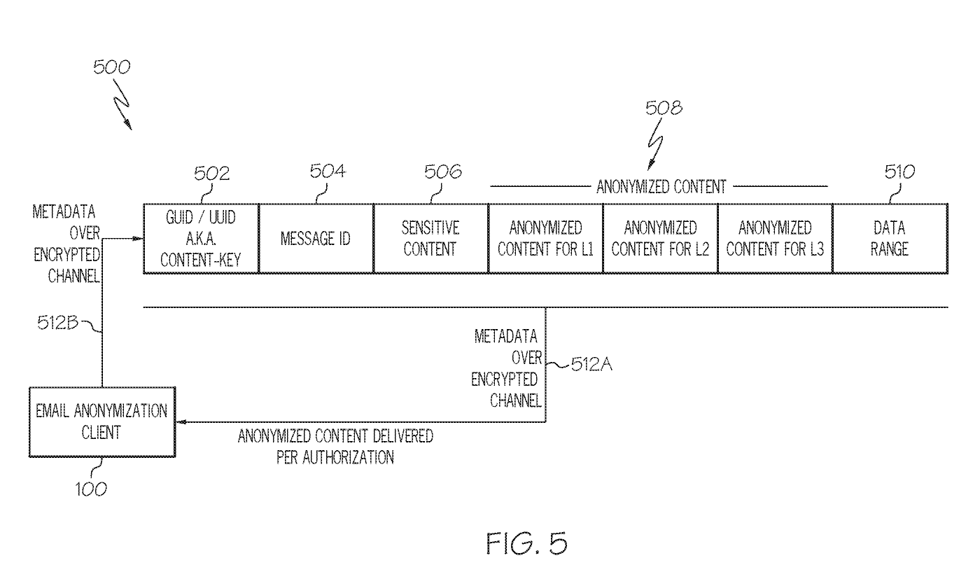

Referring to FIG. 1, after preparing the content-key in step 106, the anonymizer server component 102 may update metadata containing the content-key and date range associated with the anonymization at step 108. With reference to FIG. 5, an exemplary depiction of the anonymization metadata 500 is provided. FIG. 5 shows the content anonymization metadata 500 including a GUID/UUID (content-key) 502, message id 504, sensitive content 506, date range 510, as well as three exemplary levels of anonymization 508 for level 1, level 2, and level 3. As described with respect to exemplary embodiments, the content anonymization metadata may be updated based on an instruction from the user or automatically by the client component 100. In certain embodiments, metadata related details may be shared as attachments, and may be, for example, stored in a table or database structure contain an entry for the anonymization metadata fields described herein and within the scope of the present disclosure. Shown in FIG. 5, after updating the metadata 500, systems and methods in this embodiment may broadcast or send the updated anonymization metadata to one or more client components. With more detail, the client component 100 sends the metadata across to the server component 102 over a secure or encrypted communications channel 512B. On the server component 102, the anonymized content may be prepared. Upon preparing the content anonymization metadata, the server component may broadcast the updated metadata to all clients upon receiving, for example, a synchronization request from a client email component 100. The anonymization metadata that is broadcast to the client components 100 may be a subset of the universe of anonymization metadata 500. For example, in some embodiments a GUID/UUID 502, MessageID 504, sensitive data 506 (to match), date range 510 (to match), and anonymized content 508 (to replace) may be broadcast to the client components 100. As described herein, the client components then use that metadata to identify and replace the sensitive content. As with the communication from the client component to the server to generate the anonymized content, the broadcast of the metadata from the server component to the client components may occur over encrypted and secure channels 512A.

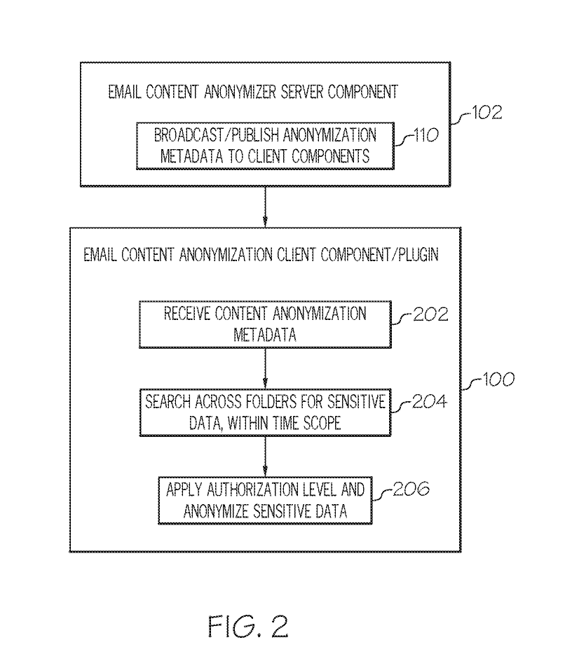

Referring now to the exemplary embodiment depicted in FIG. 2, one or more email content anonymization components 100 detects the updated content anonymization metadata and receives the content anonymization metadata 202 from the anonymization server component 102. Within the scope of the present disclosure, the client component 100 non-intrusively processes the content anonymization metadata by parsing the metadata to identify a content-key and in some embodiments message header field data associated with the sensitive content. In the background, i.e., non-intrusively, the client component 100 will search across folders for sensitive data 204 associated with the content-key. In some embodiments, the client component 100 may interrogate the anonymizer server component 102 as part of searching for sensitive data. In such embodiments, the sensitive content may not be included in the metadata and the client component may interrogate the anonymization server component to facilitate and exchange of the sensitive content or an identifier thereof in order to enable the client component to identify and search for instantiations of the sensitive content.

Continuing with the example depicted in FIG. 2, the client component 100 searches across a mailbox for sensitive data within the time scope and date range 204. Such a search may include searching one or more directories, subdirectories, and/or folders for messages related to the sensitive content identifier. Such a search may occur by parsing message header field data for messages in each mailbox to identify message header field data associated with the sensitive content and the content anonymization metadata. In certain embodiments, the client component or plugin 100 may determine a thread of messages stemming from the root message containing the sensitive content by, for example, identifying one or more messages whose message header fields reference a message identifier associated with sensitive content identifier, as shown in FIG. 3. In certain embodiments, a thread of messages related to the sensitive content may be identified by analyzing and searching for messages that include message header field data referencing a message identifier of a message that references one or more messages whose message header fields reference the message identifier of the root message containing the sensitive content.

In certain embodiments, the client component 100 may, after receiving content anonymization metadata 202, monitor one or more inbound messages and/or outbound messages, and determine whether the inbound or outbound message includes the sensitive content. In some embodiments, the client component 100 determines whether the message includes the sensitive content prior to granting access or displaying the message. In some embodiments, the client component 100 determines whether an outbound message includes the sensitive content prior to the message being sent from the mailbox. The client component 100 may determine whether the inbound or outbound message contains the sensitive content by utilizing the content-key to identify the sensitive content and anonymize it according to the corresponding content anonymization metadata. In certain embodiments, the client component 100 may automatically anonymize identified sensitive content according to the received content anonymization metadata in the inbound or outbound message.

Embodiments of the present disclosure can be oriented by way of example, following along with FIG. 3. For the example, there are two colleagues employed by a large business entity working on the same project, Sally from accounting, and Rob from engineering. Sally and Rob are both involved with the entity's development of the newest product. The product is still in the prototyping and development stage, and the project is referred to by those whom are privy to its existence as “RedRails.” Sally and Rob were instructed to work together to develop a bill of materials and budget for developing a prototype of RedRails. RedRails is confidential, even within the company, so Sally and Rob are not supposed to reveal its existence to anyone without a level one clearance. But, Sally and Rob know they cannot complete their task without support from others within their respective departments.

Sally composes an email message to Rob regarding RedRails. In the body of the message, Sally writes: “Rob, I'm pleased that you and I will be working together on the RedRails prototype. We need to get started on the bill of materials and budget for the prototype ASAP. Please send me a list of materials you and others in engineering estimate for the prototype so that I and others in the accounting department can start to develop the budget.” Referring to FIG. 3, Sally's message corresponds to the root message 302. Because Sally knew that Rob had the requisite level one clearance, she didn't anonymize the project name “RedRails” in her message to Rob, especially because Rob was the only recipient. Sally sent the message to Rob without any anonymization. Rob received the message and composed a reply to Sally, stating “Thanks Sally, I'll work with my team over the next day or so to cull together an initial BOM for RedRails and send it your way.” With reference to FIG. 3, Rob's reply corresponds to message 304, as can be seen by the In-Reply-To field with value 1, referring to message 302 in FIG. 3. Rob sent the reply to Sally. Sally replied back, stating “Great, keep me in the loop.” Sally's sur-reply to Rob's reply corresponds to message 306, as can be seen by the In-Reply-To field with value 3, referring to Rob's reply message 304.

Rob immediately got to work. Rob wanted to use his most trusted engineer, Jeff, to support him in developing the bill of materials for RedRails. With Sally's reply message regarding RedRails still open, Rob selected to reply and add Jeff's email address to the intended recipients to bring Jeff into the conversation between him and Sally. The message Rob composed said: “Jeff, I need some help putting together a bill of materials for the following list of items. Can you help?” Rob's reply to Sally and Jeff included the chain of the original message from Sally to Rob, Rob's reply to that message, and Sally's reply back to Rob. This message including Jeff and Sally corresponds to message 308, as can be seen from the In-Reply-To field with value 3, again corresponding to Rob's reply message 304.

Upon seeing Rob's reply to Sally and Jeff, Sally noticed that her original message, which used the name “RedRails,” was included as part of the reply chain on the message to Jeff. Sally knew that Jeff did not have a level one clearance and was not to know of RedRails. Sally never intended her message using the codename “RedRails” to be seen by anyone other than Rob, and she chose not to anonymize or protect the sensitive project name in her initial email to Rob because Rob had a level one clearance. Sally did not expect Rob to forward her email with the sensitive content to an unintended recipient. The sensitive information had been inadvertently leaked to Jeff.

Utilizing an embodiment of a content anonymizer client component 100, as described herein, Sally opened Rob's message to her and Jeff to initiate anonymization of the sensitive content “RedRails.” In one embodiment, Sally highlights the word “RedRails” at the bottom of the thread in her initial email to Rob, right clicks, and selects anonymize. In this example, Sally selects a standard anonymization, specifying that only recipients with level one clearance can de-anonymize the content, and selects that the anonymization should last for six months, until the expected public announcement of RedRails. Sally then clicks “submit,” and the content anonymizer client component 100 shares the anonymization information with the content anonymizer server component 102. Upon receiving the information from the client component, the server component obtains the message/document identification associated with the email in which the sensitive content was contained; in this example, Sally's original message 302. The server component also receives an indication that the sensitive content associated with Sally's original message should only be viewable by recipients with a level one clearance and that the sensitive content should be protected for six months.

The content anonymizer server component 102 then prepares the anonymized content and a content-key. In certain embodiments, the anonymized content may take the form of a format preserving token, as are known in the art. The content anonymization server then updates metadata associated with the message identifier of Sally's original message to contain the content-key and the anonymization life span. The updated metadata is then broadcasted or published to the client components.

Both Rob and Jeff's content anonymization client components, as described in this exemplary embodiment, receive the broadcast content anonymization metadata from the content anonymization server component. In other embodiments, the content anonymization metadata may be received by the client component when the client component synchronizes with the email server. Upon parsing the updated metadata, the client component 100 searches across folders for the sensitive data within the anonymization life span or time scope. That is, the client component on Rob's machine will search across folders for messages containing the sensitive content, and upon locating that information, will apply the specified level of anonymization according to Rob's authorization level. In this example, because Rob has a level one clearance, he is still able to view the sensitive content, “RedRails.” The client component on Jeff's machine, in this particular embodiment, would locate and identify the sensitive content in the inbox folder as part of the thread between Jeff, Rob, and Sally, as identified in FIG. 3 as Thread 2. Upon locating the sensitive content, the client component on Jeff's machine applies the specified level of authorization according to Jeff's authorization level. In this example, because Jeff does not have a level one clearance, the sensitive content, “RedRails,” may be completely anonymized and no longer viewable by Jeff, who does not possess the requisite clearance and thus cannot de-anonymize the sensitive content.

In certain embodiments within the present disclosure standard Internet message format message header fields are leveraged by the content anonymization client component 100 in order to search across folders for sensitive data within the time scope to identify the sensitive content. One of ordinary skill in the art would realize that there are several different techniques of searching and identifying sensitive content based on the message header field within the scope of the present invention. Examples of searching techniques include, but are not limited to, linear search algorithms, binary search algorithms including binary search trees, and/or hashing search algorithms.

Continuing the current example, in certain embodiments, Sally's original email containing the sensitive content may contain a message header field identifying her message with message id “Sally1”, or Message ID: 1, as shown in FIG. 3. When Rob's anonymization client component receives the content anonymization metadata, it may search across folders in Rob's email mailbox to identify all messages with message header fields that reference “Sally1,” (Message ID: 1) the message id of the message containing the sensitive content. In the exemplary embodiment described herein, the client component on Rob's machine may identify several messages related to the sensitive content, and at different levels of relation using different searching techniques.

For example, the client component may detect that Sally's original message is stored in Rob's inbox, from when Sally sent it to him. In some embodiments, the client component would identify Sally's message in Rob's inbox as related to the sensitive content because Sally's message included message header field data, namely the message id, matching the message containing the sensitive content, “Sally1.”

The client component may also identify Rob's reply to Sally's original message in Rob's outbox folder as related to the sensitive content because the reply includes Sally's original message with the sensitive content. That is, Rob's reply to Sally's original message because Rob's reply message may contain a message header field, namely the in-reply-to field, which references the “Sally1” message.

The client component may also identify Sally's sur-reply 306 to Rob's reply 304 in Rob's inbox as a message related to the sensitive content because it is part of a chain of messages containing Sally's original message 302 containing the sensitive content. There are various techniques within the present disclosure for identifying this message as related to the sensitive content in this situation. First, Sally's sur-reply 306 may be identified as being related to the sensitive content based on an analysis of the in-reply-to message header field of the sur-reply. In some embodiments, Sally's sur-reply 306 would include all of the messages to which it replied, which would be the message id of Rob's reply 304, which itself was a reply to “Sally1” 302. Thus, Sally's sur-reply 306, which is two degrees separated from Sally1 302, would be identified as related to the sensitive content within the scope of the present disclosure. Alternatively, in this example, Sally's sur-reply 306 could be identified by the client component 100 as being related to the sensitive content based on data within the references message header field which may specify a thread identifier that itself is associated with the “Sally1” message.

Finally, the client component may identify Rob's message to Jeff 308 in Rob's outbox as a message related to the sensitive content. Similar to the last example, this message could be identified as related to the sensitive content because it was a reply to Sally's message and a chain or thread could be formed tracing the in-reply-to field and/or the references field back to the Sally1 message. If Rob's message to Jeff was not a reply, but rather, was forwarded to Jeff, the client component may identify in Rob's outbox the message forwarded to Jeff at least through the references header field, which itself references a message that replied to a message on the main thread between Sally and Rob, and ultimately could be traced up to the “Sally1” message.

Even further removed from the Sally1 message, but still identifiable by the client component in some embodiments of the present disclosure, the client component on Jeff's machine may identify Rob's email to Jeff 308 as being related to the sensitive content based on a trace of the message header fields in the message to Jeff. That is, in certain embodiments, the message to Jeff could be identified in Jeff's inbox as related to the sensitive data if it referenced a thread that was related to the Sally1 message. Or, in a different example, the client component on Jeff's machine may identify the message as related to the sensitive components by parsing the in-reply-to and references message header fields for a direct reference to Sally1, or a direct reference to another message that references Sally1.

While many examples and embodiments herein have been described in the context of email messaging and communications, one of ordinary skill in the art would appreciate that the present disclosure and concepts described herein could also be applied to other types of messaging, for example, instant messaging.

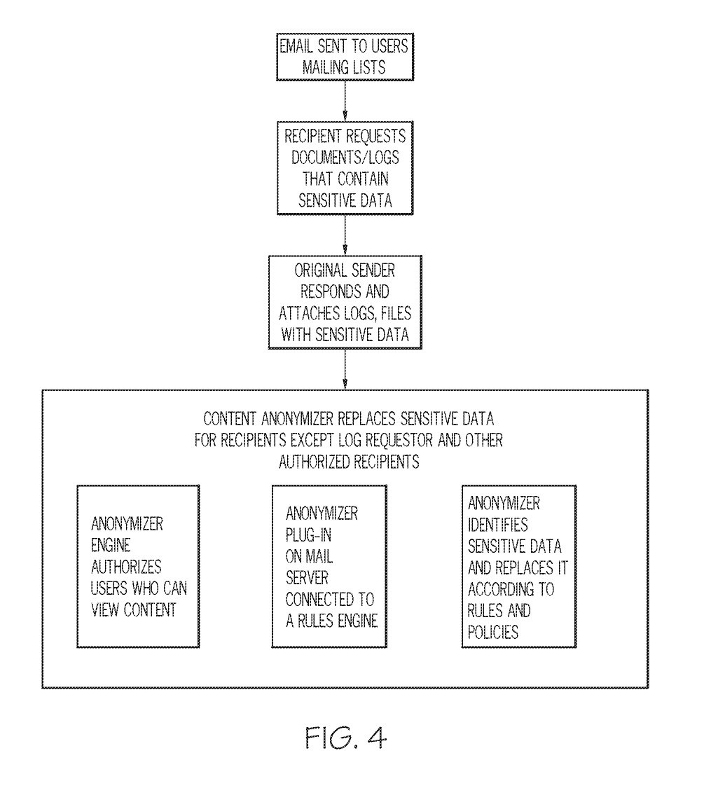

The flowcharts and diagrams in FIGS. 1-4 illustrate the architecture, functionality, and operation of possible implementations of systems, methods, and computer program products according to various aspects of the present disclosure. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a,” “an,” and “the” are intended to comprise the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of means or step plus function elements in the claims below are intended to comprise any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. For example, this disclosure comprises possible combinations of the various elements and features disclosed herein, and the particular elements and features presented in the claims and disclosed above may be combined with each other in other ways within the scope of the application, such that the application should be recognized as also directed to other embodiments comprising other possible combinations. The aspects of the disclosure herein were chosen and described in order to best explain the principles of the disclosure and the practical application and to enable others of ordinary skill in the art to understand the disclosure with various modifications as are suited to the particular use contemplated.

What is claimed is:

1. A method comprising:
receiving content anonymization metadata from an anonymization server, the content anonymization metadata comprising a sensitive content identifier and message header field data associated with the sensitive content identifier;
in response to receiving the content anonymization metadata, determining a plurality of messages related to the sensitive content identifier based on the message header field data associated with the sensitive content identifier;
determining whether a message of the plurality of messages related to the sensitive content identifier includes sensitive content; and
in response to determining that a message of the plurality of messages related to the sensitive content identifier includes the sensitive content, automatically anonymizing the sensitive content according to the content anonymization metadata.

2. The method of claim 1, wherein determining a plurality of messages related to the sensitive content identifier based on the message header field data associated with the sensitive content identifier comprises identifying a plurality of messages containing message header field data matching the message header field data identified in the content anonymization metadata.

3. The method of claim 2, wherein the message header field data associated with the sensitive content identifier comprises a message identifier of a root message containing the sensitive content.

4. The method of claim 3, wherein the plurality of messages related to the sensitive content identifier comprises messages containing message header field data that references the message identifier of the root message containing the sensitive content.

5. The method of claim 4, wherein the message header field data that references the message identifier of the root message containing the sensitive content is contained in one or more of a message identifier message header field, an in-reply-to message header field, or a references message header field.

6. The method of claim 4, wherein determining the plurality of messages related to the sensitive content identifier further comprises determining a thread of messages stemming from the root message containing the sensitive content.

7. The method of claim 6, wherein determining the thread of messages stemming from the root message containing the sensitive content comprises parsing a references message header field of a message that includes the message identifier of the root message containing the sensitive content.

8. The method of claim 3, wherein the plurality of messages related to the sensitive content identifier comprises a first group of messages and a second group of messages, the first group of messages being defined by messages containing message header field data that references the message identifier of the root message containing the sensitive content, and the second group of messages being defined by messages containing message header field data that references a message belonging to the first group of messages.

9. The method of claim 1, further comprising:
in response to receiving the content anonymization metadata, monitoring a plurality of inbound messages and outbound messages;
determining whether the inbound or outbound message includes the sensitive content; and
in response to determining that the inbound message or outbound message includes the sensitive content, automatically anonymizing the sensitive content in the inbound or outbound message according to the content anonymization metadata.

10. The method of claim 1, wherein the content anonymization metadata is received at a first client component, and further comprising:
determining a first level of authorization associated with the first client component; and
in response to determining that a message of the plurality of messages related to the sensitive content identifier includes the sensitive content, automatically anonymizing the sensitive content according to the content anonymization metadata and the first level of authorization.

11. The method of claim 10, wherein the content anonymization metadata is received at the first client component and a second client component, and further comprising:
determining a second level of authorization associated with the second client component; and
in response to determining that a message of the plurality of messages related to the sensitive content identifier includes the sensitive content, automatically anonymizing the sensitive content according to the content anonymization metadata and the second level of authorization.

12. The method of claim 11, wherein the sensitive data is viewable at the first level of authorization by the first client component, and the sensitive data is not viewable at the second level of authorization by the second client component.

13. The method of claim 1, wherein the content anonymization metadata further identifies a date range specifying the time period during which the sensitive content will be anonymized.

14. The method of claim 1, wherein determining a plurality of messages related to the sensitive content identifier based on the message header field data associated with the sensitive content identifier comprises searching a plurality of folders within a mailbox for the message header field data associated with the sensitive content identifier.

15. The method of claim 3, wherein the sensitive content is contained in an attachment to the root message.

16. A non-transitory computer readable storage medium storing instructions that are executable to cause a system to perform operations comprising:
receiving content anonymization metadata from an anonymization server, the content anonymization metadata comprising a sensitive content identifier and message header field data associated with the sensitive content identifier;
in response to receiving the content anonymization metadata, determining a plurality of messages related to the sensitive content identifier based on the message header field data associated with the sensitive content identifier, wherein the plurality of messages related to the sensitive content identifier comprises a first group of messages and a second group of messages, the first group of messages being defined by messages containing message header field data that references the message identifier of a root message containing sensitive content, and the second group of messages being defined by messages containing message header field data that references a message belonging to the first group of messages;
determining whether a message of the plurality of messages related to the sensitive content identifier includes sensitive content; and
in response to determining that a message of the plurality of messages related to the sensitive content identifier includes the sensitive content, automatically anonymizing the sensitive content according to the content anonymization metadata.

17. The non-transitory computer readable storage medium of claim 16, wherein determining a plurality of messages related to the sensitive content identifier based on the message header field data associated with the sensitive content identifier comprises identifying a plurality of messages containing message header field data matching the message header field data identified in the content anonymization metadata.

18. The non-transitory computer readable storage medium of claim 17, wherein the message header field data associated with the sensitive content identifier comprises a message identifier of a root message containing the sensitive content.

19. The non-transitory computer readable storage medium of claim 18, wherein the plurality of messages related to the sensitive content identifier comprises a first group of messages and a second group of messages, the first group of messages being defined by messages containing message header field data that references the message identifier of the root message containing the sensitive content, and the second group of messages being defined by messages containing message header field data that references a message belonging to the first group of messages.

20. A computer comprising:
a processor; and
a non-transitory computer-readable storage medium storing computer-readable instructions that are executable by the processor to cause the computer to perform:
receiving content anonymization metadata from an anonymization server, the content anonymization metadata comprising a sensitive content identifier and message header field data associated with the sensitive content identifier;
in response to receiving the content anonymization metadata, determining a plurality of messages related to the sensitive content identifier based on the message header field data associated with the sensitive content identifier;
determining whether a message of the plurality of messages related to the sensitive content identifier includes sensitive content; and
in response to determining that a message of the plurality of messages related to the sensitive content identifier includes the sensitive content, automatically anonymizing the sensitive content according to the content anonymization metadata.
